(19) United States
(12) Patent Application Publication
(10) Pub. No.: US 2011/0200059 A1
(43) Pub. Date: Aug. 18, 2011

(54) BIT Inversion For Communication Interface

(76) Inventor: Siamak Tavallaei, Spring, TX (US)

(21) Appl. No.: 13/126,032

(22) PCT Filed: Oct. 30, 2008
(86) PCT No.: PCT/US08/81853

§ 371 Date: Apr. 26, 2011

(51) Int. Cl. H04L 12/56

(52) U.S. Cl. 370/476

(57) ABSTRACT

In accordance with embodiments, a system includes a first component and a second component. The system also includes a communication interface between the first and second components. A communication packet transmitted from the first component to the second component comprises a bit inversion identifier.

### BACKGROUND

Selective data bit inversion can reduce power consumption in various circumstances. In general, the power consumption is reduced by reducing the occurrences of forcing a default voltage level to another state (either high or low). For example, selective bit inversion can be used to reduce the power consumption of storing data in volatile memory. Selective bit inversion can also be used to reduce power consumption of transmitting data over a communication interface.

In order to correctly interpret inverted bits and/or restore the original data, it is necessary to provide notification regarding the occurrence of bit inversion. For example, a pin and corresponding logic can be added to electronic components in order to signal when bit inversion has occurred. Unfortunately, adding such a pin undesirably increases the cost of employing bit inversion techniques.

### BRIEF DESCRIPTION OF THE DRAWINGS

For a detailed description of exemplary embodiments of the invention, reference will now be made to the accompanying drawings in which:

FIG. 1A illustrates a system in accordance with embodiments;

FIG. 1B illustrates another system in accordance with embodiments;

FIG. 2 illustrates a communication packet in accordance with embodiments;

FIGS. 3A and 3B illustrate communication packet groups in accordance with embodiments;

FIG. 4 illustrates a method in accordance with embodiments; and

FIG. 5 illustrates a computer system in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments are directed to methods and systems for bit inversion. In at least some embodiments, a communication packet includes a bit inversion indicator associated with inverted bits of the communication packet and/or inverted bits of at least one subsequent communication packet. Components receiving the communication packets are configured to check for the bit inversion indicator and to handle inverted bits accordingly.

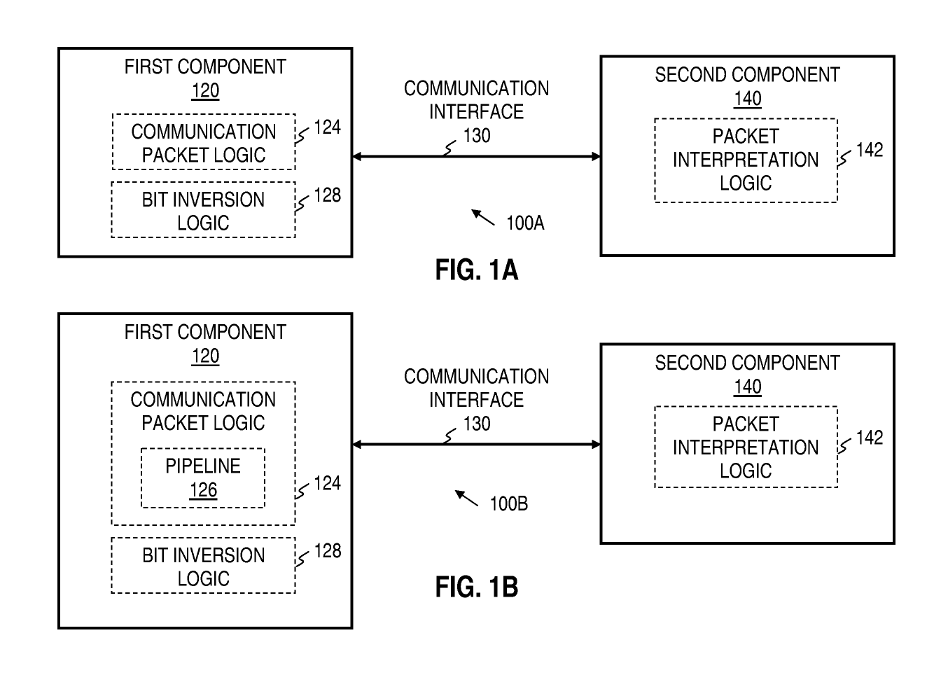

FIG. 1A illustrates a system 100A in accordance with embodiments. In the system 100A, a first component 120 couples to a second component 140 via a communication interface 130. For example, in some embodiments, the first component 120 is a processor and the second component 140 is a dynamic random access memory (DRAM). In alternative embodiments, the first component 120 is a transmitter (or transceiver) and the second component 140 is a receiver (or transceiver). Other example of first and second components include, but are not limited to, a memory controller paired with a memory device, an I/O bus controller paired with an I/O device, a link initiator paired with end-device, or a link responder paired with an link initiator.

As shown, the first component 120 comprises communication packet logic 124 and bit inversion logic 128. The communication packet logic 124 prepares communication packets to be transmitted from the first component 120 to the second component 140. As an example, if the first component 120 corresponds to a processor and the second component 140 corresponds to DRAM, then communication packets may correspond to write packets. As another example, if the first component 120 corresponds to a transmitter and the second component 140 corresponds to a receiver, then communication packets may correspond to management or data inquiries, snoops, or directory updates.

The bit inversion logic 128 receives the communication packets (or information regarding the communication packets) and determines if bit inversion is appropriate (e.g., whether bit inversion reduces the occurrences of forcing a default voltage level to another state (either high or low)). If bit inversion is not appropriate (for reducing power, enhancing signal integrity, increasing security, reducing error probability), communication packets are transmitted from the first component 120 to the second component 140 without a bit inversion indicator. Alternatively, the communication packets could be transmitted with a bit inversion indicator that signals bit inversion is not being used.

If bit inversion is appropriate, the bit inversion logic 128 modifies communication packets by inverting bits or directs the communication packet logic 124 to modify communication packets by inverting bits based on a predetermined algorithm. The bit inversion logic 128 also causes corresponding bit inversion indicators to be included within communication packets. For example, in some embodiments, each communication packet having inverted bits may include its own bit inversion indicator. Additionally or alternatively, a communication packet may include a bit inversion indicator for at least one subsequent communication packet.

As shown, the second component 140 comprises packet interpretation logic 142 to support interpretation and handling of communication packets received via the communication interface 130. In accordance with embodiments, the packet interpretation logic 142 checks received communication packets for the existence and/or value of bit inversion indicators. Upon detecting the existence of a bit inversion indicator, the packet interpretation logic 142 operates to interpret and/or restore the corresponding inverted bits based on the predetermined algorithm. Alternatively, upon detecting a predetermined bit inversion indicator value, the packet interpretation logic 142 operates to interpret and/or restore the corresponding inverted bits based on the predetermined algorithm.

FIG. 1B illustrates another system 100B in accordance with embodiments. In FIG. 1B, the communication packet logic 124 comprises a pipeline 126. In other words, the process of preparing and transmitting communication packets involves several processing stages. By accessing the pipeline 126, the bit inversion logic 128 receives communication packets (or information regarding the communication packets) that will not be transmitted until several cycles have passed. Accordingly, the bit inversion logic 128 can determine if bit inversion is appropriate for pending communication packets in the pipeline. As an example, if the pipeline 126 has ten stages, the bit inversion logic 128 can determine if bit inversion is appropriate for up to a threshold number (ten being the highest possible amount in this example) of communication packets in the pipeline.

Again, if bit inversion is appropriate, the bit inversion logic 128 modifies communication packets by inverting bits or directs the communication packet logic 124 to modify communication packets by inverting bits. The bit inversion logic 128 also causes corresponding bit inversion indicators to be included within communication packets. As previously described, each communication packet may have its own bit inversion indicator and/or a bit inversion indicator for at least one subsequent communication packet.

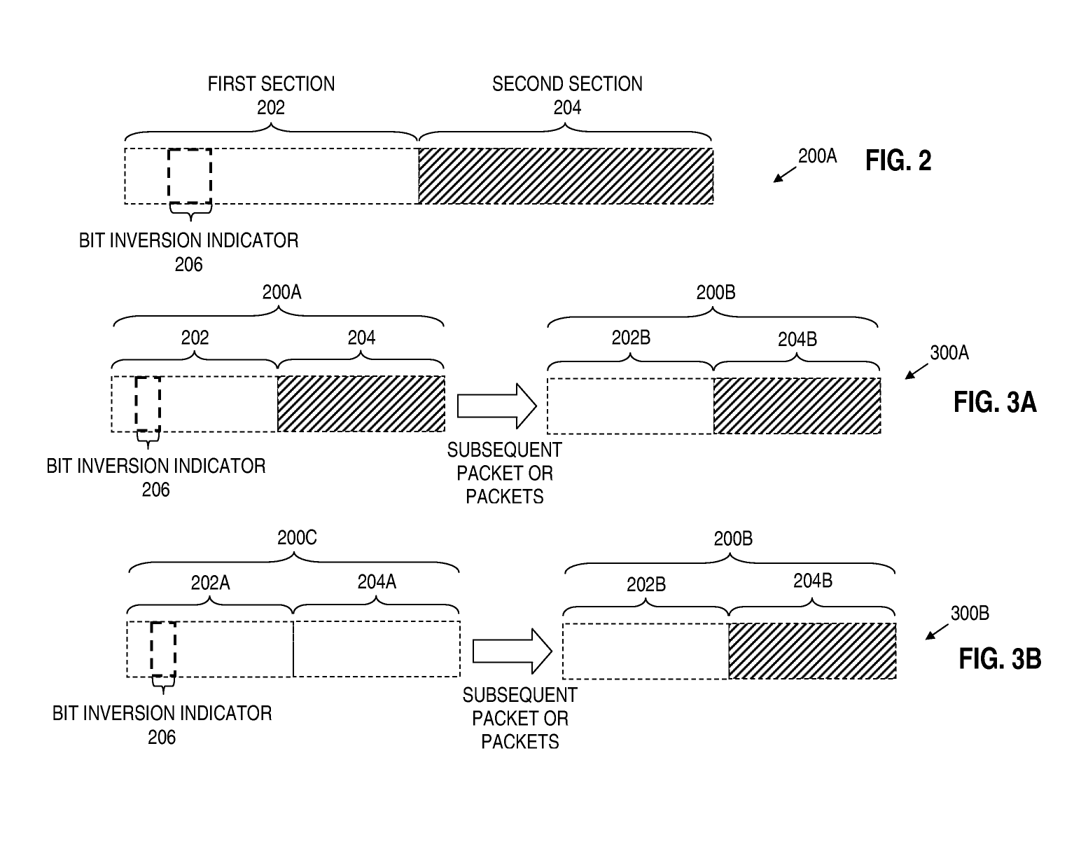

FIG. 2 illustrates a communication packet 200A in accordance with embodiments. As shown, the communication packet 200A comprises a first section 202 having non-inverted bits and a second section 204 having inverted bits (represented by diagonal stripes). The first section 202 comprises a bit inversion indicator 206 associated with the second section 204. In other words, the bit inversion indicator 206 is used to signal that the second section 204 has inverted bits.

In at least some embodiments, the first section 202 corresponds to at least part of a command field of the communication packet 200A. For example, the command field may indicate a write operation, a management operation, a snoop operation, a directory update operation, or other commands. In such embodiments, the second section 204 corresponds to part of a command field, a data field and/or an address field. In general, the second section 204 may be any section that follows the bit inversion indicator 206 and that allows sufficient time for the second component 140 to be configured to handle inverted bits rather than non-inverted bits.

FIG. 3A illustrates a communication packet group 300A in accordance with embodiments. In FIG. 3A, the communication packet group 300A comprises the communication packet 200A followed by at least one subsequent communication packet 200B. At least one subsequent communication packet 200B has inverted bits signaled by the bit inversion indicator 206 of the communication packet 200A. In accordance with embodiments, the subsequent communication packet 200B may comprise a first section 202B having non-inverted bits and a second section 204B having inverted bits. However, other subsequent communication packet embodiments may vary. For example, some subsequent communication packets may have no inverted bits or all inverted bits. Also, the placement of inverted bits may vary (e.g., the first section 202B may have inverted bits and the second section 204B may have non-inverted bits).

In general, the complexity of bit inversion signaling should be minimized to facilitate processing requirements and/or placement of the bit inversion indicator 206 into communication packets. For example, many communication protocols do not currently use all the bits in the command field and/or define special use bits that are not often used. Such bits (individually or together) can be used as the bit inversion indicator 206. In these embodiments, the location of the bit inversion indicator 206 within the first section 202 corresponds to the available bit(s) that are not being used. Depending on the number of available bits in the command field and the amount of detail desired, bit inversion signaling can be simple or complex. A simple example of bit inversion signaling could employ a single bit. If the bit is asserted, a predetermined section of the same communication packet or a subsequent communication packet will be interpreted (e.g., by the second component 140) to have inverted bits. A complex example of bit inversion signaling may employ four bits (bits 0-3). As an example, bit 0 signals the existence (or not) of bit inversion and bits 1-3 signal which of three communication packets have inverted bits (e.g., the current communication packer and two subsequent communication packets) in a predetermined section (e.g., a data field). As another example, bit 0 signals the existence of bit inversion and bits 1-3 signal which predetermined fields (e.g., part of a command field, an address field, or a data field) of a communication packet are inverted. Other embodiments are possible as well without limitation to the number of bits being used or without limitation to the placement of bit inversion indicator.

FIG. 3B illustrates a communication packet group 300B in accordance with embodiments. As shown, the communication packet group 300B comprises a communication packet 200C followed by at least one subsequent communication packet 200B. In FIG. 3B, the communication packet 200C comprises the bit inversion indicator 206, but does not have inverted bits. However, the at least one subsequent communication packet 200B has inverted bits signaled by the bit inversion indicator 206 of the communication packet 200C. As previously discussed, embodiments of the subsequent communication packet 200B vary. As is shown, the subsequent communication packet 200B may have a first section 202B with non-inverted bits and a second section 204B with inverted bits. Bit inversion signaling also may vary and may be based on available bits in a command field as previously discussed for FIG. 3A.

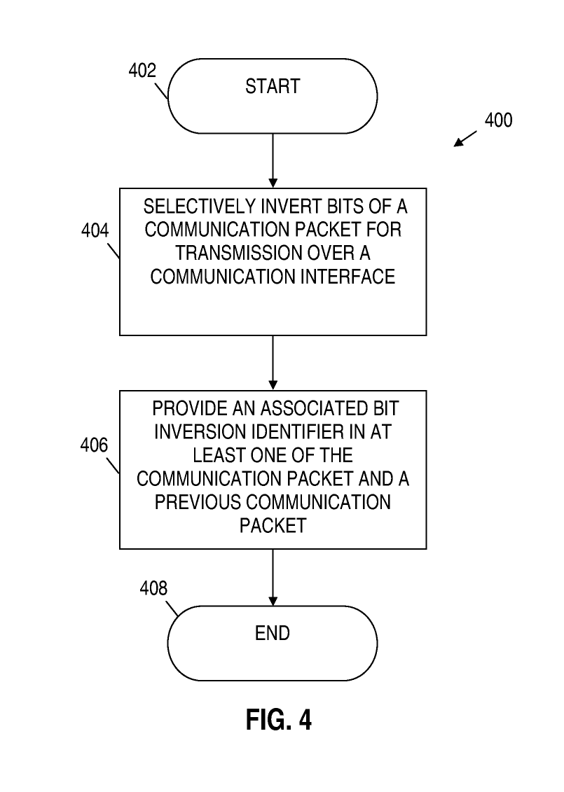

In accordance with embodiments, the selective bit inversion reduces power consumption of transmitting data over the communication interface 130 by reducing the occurrences of forcing a default voltage level of the communication interface 130 to another state (either high or low). FIG. 4 illustrates a method 400 in accordance with embodiments. As shown, the method 400 starts at block 402 and continues by selectively inverting bits of a communication packet for transmission over a communication interface (block 404). At block 406, an associated bit inversion identifier is provided in at least one of the communication packet and a previous communication packet and the method 400 ends at block 408. As an example, providing the associated bit inversion identifier (as in block 406) may comprise preparing a communication packet command field having the bit inversion identifier.

In accordance with some embodiments, the method 400 may also comprise determining if a length of time needed for bit inversion signaling is less than a predetermined threshold and, if so, providing the associated bit inversion identifier in the communication packet having inverted bits. If the length of time needed for bit inversion signaling is greater than a predetermined threshold, the method 400 involves providing the associated bit inversion identifier in a previous communication packet. The method 400 also may comprise analyzing information in a pipeline and determining whether to invert bits of the communication packet based on said information. In some cases, the method 400 involves analyzing information in a pipeline and determining to invert bits in a plurality of communication packets based on said information. In such case, the bit inversion identifier is associated with the plurality of communication packets.

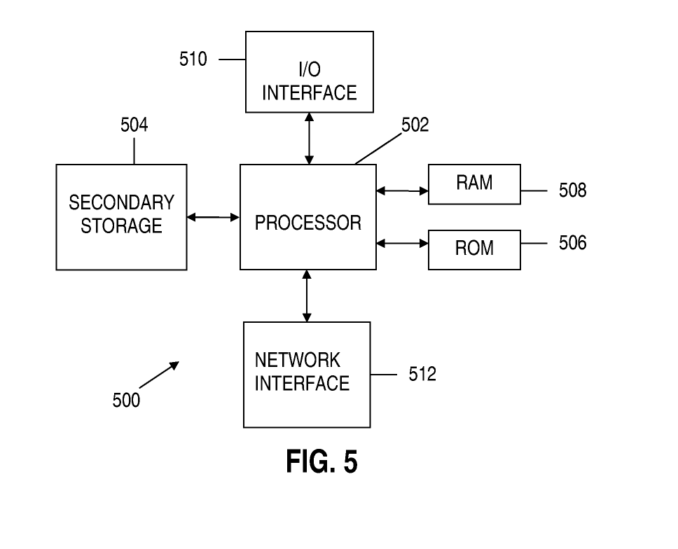

Without limitation to other embodiments, the components and methods described above may be implemented on a general-purpose computer or server. FIG. 5 illustrates a computer system 500 in accordance with embodiments. The computer system 500 includes a processor 502. It should be appreciated that processor 502 may be at least one of a variety of processors such as, for example, a microprocessor, a microcontroller, a central processor unit (CPU), a main processing unit (MPU), a digital signal processor (DSP), an advanced reduced instruction set computing (RISC) machine, an (ARM) processor, etc. The processor 502 executes coded instructions which may be present in a main memory of the processor 502 (e.g., within random-access memory (RAM) 508) and/or within an on-board memory of the processor 502. RAM 508 may be correspond to dynamic RAM (DRAM), synchronous dynamic RAM (SDRAM), and/or any other type of RAM device. The processor 502 also communicates with a secondary storage 504 and a read-only memory (ROM) 506 as needed.

To facilitate communication with other devices the processor 502 couples to an input/output (I/O) interface 510 and a network interface 512. As an example, the I/O interface 510 can be used to interface with devices such as a keyboard, a touchpad, buttons, a keypad, switches, dials, a mouse, a track-ball, a card reader, a liquid crystal display (LCD), a printer, a touch screen display, a light-emitting diode (LED), or other devices. Meanwhile, the network interface 512 may support medium access controller (MAC) layer functions and physical (PHY) layer functions. The network interface 512 supports wired and/or wireless communications.

The secondary storage 504 is typically comprised of one or more disk drives or tape drives and is used for non-volatile storage of data and as an over-flow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage 504. The RAM 508 is used to store volatile data and perhaps to store instructions. Access to both ROM 506 and RAM 508 is typically faster than to secondary storage 504.

In accordance with embodiments, the computer system 500 implements at least one component of FIG. 1 (e.g., the first component 120, the second component 140, or both). For example, the first component 120 of FIG. 1 may be representative of the processor 502 and the second component 140 of FIG. 1 may be representative of RAM 508. In alternative embodiments, the first component 120 and second component 140 of FIG. 1 are representative of a transmitter, receiver, transceiver, or other PHY layer components of the network interface 512. [Any other examples? . . . ]

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a first component;
a second component; and
a communication interface between the first and second components,
wherein a communication packet transmitted from the first component to the second component comprises a bit inversion identifier.

2. The system of claim 1 wherein the bit inversion identifier is located in a first section of the communication packet and indicates bit inversion for a second section of the communication packet.

3. The system of claim 2 wherein the first section comprises a first part of a command field and the second section comprises a second part of the command field.

4. The system of claim 2 wherein the first section comprises a command field and the second section comprises an address field.

5. The system of claim 2 wherein the first section comprises a command field and the second section comprises a data field.

6. The system of claim 1 wherein the bit inversion identifier indicates bit inversion for at least one subsequent communication packet.

7. The system of claim 1 wherein the bit inversion identifier indicates bit inversion for at least part of the communication packet and at least one subsequent communication packet.

8. The system of claim 1 wherein the second component comprises Dynamic Random Access Memory (DRAM) and the communication packet comprises a write packet.

9. The system of claim 1 wherein the bit inversion associated with the bit inversion identifier decreases power consumption of transmitting at least one communication packet over the communication interface.

10. A method, comprising:
selectively inverting bits of a communication packet for transmission over a communication interface; and
providing an associated bit inversion identifier in at least one of the communication packet and a previous communication packet.

11. The method of claim 10 wherein providing the associated bit inversion identifier comprises preparing a communication packet command field having the bit inversion identifier.

12. The method of claim 10 further comprising determining if a length of time needed for bit inversion signaling is less than a predetermined threshold and, if so, providing the associated bit inversion identifier in the communication packet.

13. The method of claim 10 further comprising determining if a length of time needed for bit inversion signaling is greater than a predetermined threshold and, if so, providing the associated bit inversion identifier in the previous communication packet.

14. The method of claim 10 further comprising analyzing information in a pipeline and determining whether to invert bits of the communication packet based on said information.

15. The method of claim 10 further comprising analyzing information in a pipeline and determining to invert bits in a plurality of communication packets based on said information, wherein said bit inversion identifier is associated with the plurality of communication packets.
